(19) United States
(12) Patent Application Publication
(10) Pub. No.: US 2007/0013289 A1
(43) Pub. Date: Jan. 18, 2007

(54) Display device

(75) Inventors: Shigemi Hirasawa, Chiba (JP); Kenji Kato, Mobara (JP); Hideyuki Shintani, Mobara (JP)

Correspondence Address: MILBANK, TWEED, HADLEY & MCCLOY, 1 CHASE MANHATTAN PLAZA, NEW YORK, NY, 10005-1413, US

(73) Assignee: Hitachi Displays, Ltd.

(21) Appl. No.: 11/485,862

(22) Filed: Jul. 13, 2006

(30) Foreign Application Priority Data
Jul. 15, 2005 (JP) 2005-206694

(51) Int. Cl. H01J 1/62

(52) U.S. Cl. 313/493

(57) ABSTRACT

The object of the invention is to provide a display device, particularly to provide a display device that inhibits discharge caused in the operation of the display device utilizing field emission and enables image display for a long time. Discharge between a metal-backed film and an electron emission element is inhibited by forming a plurality of spacers arranged in a display area between a front board and a back board by an insulating material, providing a conductive metallic film on side walls of the spacer and integrating a convex portion protruded on the side of the front board with the conductive metallic film.

### CLAIM OF PRIORITY

The present application claims priority from Japanese Application JP 2005-206694 filed on Jul. 15, 2005, the content of which is hereby incorporated by reference into this application.

### FIELD OF THE INVENTION

The present invention relates to a display device, in particular, it relates to a display device provided with plural gap holding members between opposite faces of a front board on which a fluorescent screen is formed and a back board on which an electron emission element is formed, and detailedly relates to a discharge measure structure of the gap holding member.

### BACKGROUND OF THE INVENTION

A display device for making a fluorescent screen emit light by colliding an electron with the fluorescent screen and displaying an image includes a thin cathode ray tube provided with a cold cathode represented by a field emission display provided with a field emission type electron source and a surface conduction display provided with a surface conduction type electron source, and a cathode-ray tube provided with a hot cathode.

In the thin cathode ray tube, an envelope (also called a container) of the thin cathode ray tube is formed by a back board provided with plural electron emission elements, a front board provided with a fluorescent screen and a support (also called a supporting frame or a panel frame) for sealing the back board and the front board. The inside of the envelope is held in a high vacuum to facilitate the transfer of an electron emitted from the electron emission element. The electron emitted from the electron emission element collides with the fluorescent screen arranged opposite to the electron emission element and an image is displayed.

The envelope is designed so that it can resist atmospheric pressure sufficiently, however, as the front board or the back board is concave inside the envelope particularly in a display device provided with a large screen, gap holding members (hereinafter called spacers) are arranged in its image display area and concaveness inside the front board and the back board is inhibited.

The spacer is normally formed by an insulating material to prevent conduction between the front board and the backboard. As wiring for applying voltage to the electron emission element is formed on the back board and a positive electrode is formed on the front board, conduction between the front board and the back board is required to be prevented.

In this case, when the spacer is formed by an insulating material, the spacer is electrified and a new problem occurs. When the spacer is electrified, an electric field in the vicinity of the spacer is distorted, an electron emitted from the electron emission element cannot reach a predetermined fluorescent screen, and as a result, an image is distorted.

In a patent document 1, Japanese Patent Laid-Open No. 1998-334834, a patent document 2, Japanese Patent Laid-Open No. 2000-251791 and a patent document 3, Japanese Patent Laid-Open No. 1996-180821 respectively described below, means for solving such a problem is disclosed. In the patent document 1, technique for forming a high-resistance film on the surface of the body of a spacer and forming an electrode on the high-resistance film by a low-resistance member is disclosed. Further, in the patent document 1, a position which an electron emitted from the electron emission element reaches is controlled by forming the electrode in two locations on the side of a front plate and on the side of a back plate.

In the patent document 2, technique for forming a high-resistance film on the surface of a spacer formed by an insulating material and forming a low-resistance film for preventing electrification on the surface in a lower part of the spacer is disclosed. According to this configuration, an electron orbit disturbed by the electrification of the spacer can be corrected and an electron beam can be radiated to an optimum position of a fluorescent screen.

In the patent document 3, technique for stabilizing the orbit of an electron emitted from an electron emission element by arranging a semiconductive spacer on one wiring to prevent it from coming in contact with plural wiring is disclosed.

### SUMMARY OF THE INVENTION

In a display device where an image is displayed by making the inside of an envelope vacuum and making an electron emitted from a cathode collide with a fluorescent screen, a discharge phenomenon may occur between a positive electrode and another electrode in displaying an image. When discharge is caused, a problem that the service life of a panel is reduced and emission occurs in a location except a predetermined location occurs. The structure of a panel that can resist atmospheric pressure and structure for inhibiting the electrification of a spacer are examined, however, a structure for extending the service life of a display device has not been discussed.

To inhibit discharge caused between the positive electrode and another electrode, knocking is performed in a manufacturing process of the display device. However, as discharge is caused in a location in which contact between the spacer and the electrode is imperfect, there is a problem that it is difficult to specify the location of discharge.

Therefore, the invention is made to solve the above-mentioned problems of the conventional types and the object is to provide a display device where discharge caused in the operation of the display device is inhibited and the display of an image having a long service life can be realized.

To achieve such an object, the display device according to the invention addresses the problems of the background art by providing a conductive metallic film to side walls of each base of plural gap holding members which are arranged in a display area of a front board and a back board and the surface of each of the gap holding members is formed by ceramic material (high-resistance or insulating material), and by integrating a convex portion protruded on the side of the front board of the conductive metallic film, so that discharge is easily caused between a positive electrode and the conductive metallic film, and discharge between the positive electrode and an electron emission element is inhibited.

Another display device according to the invention addresses the problems of the background art by providing a conductive metallic film to side walls of a base of a gap holding member the surface of which is formed by ceramic material, and by integrating an area in which the thickness of the conductive metallic film is increased from the side of a front board toward the side of a back board, so that discharge is easily caused between a positive electrode and the conductive metallic film, and discharge between the positive electrode and an electron emission element is inhibited.

The invention is not limited to the above-mentioned configurations and the configurations of embodiments described later and various changes without deviating from technical ideas of the invention are allowed.

According to the display device according to the invention, as discharge is easily caused between the positive electrode and the conductive metallic film in the structure, discharge is hardly caused between the electron emission element and the positive electrode in normal operation and the breakdown of the electron emission element can be inhibited. As gas can be prevented from being caused by the breakdown of the electron emission element, the deterioration of luminance can be inhibited. Therefore, extremely excellent effect that the service life of the display device is greatly enhanced and the reliable display device having high quality can be realized is acquired.

Besides, according to the display device according to the invention, as a knocking process is performed in a manufacturing process between the positive electrode and the conductive metallic film and discharge is forcedly caused, discharge in normal operation can be controlled. Further, as locations where discharge is easily caused in the operation can be reduced by knocking, extremely excellent effect that a service life of the display device can be extended is acquired.

### BRIEF DESCRIPTION OF THE DRAWINGS

FIGS. 1A and 1B are explanatory drawings for explaining a first embodiment of a display device according to the invention, where FIG. 1A is a plan viewed from the side of a front board and FIG. 1B is a plan viewed from a direction shown by an arrow A in FIG. 1A;

FIG. 2 is a schematic plan showing a back board acquired by removing the front board shown in FIGS. 1A and 1B from the display device;

FIG. 3 is a schematic enlarged sectional view showing the back board viewed along a line B-B shown in FIG. 2 and the front board corresponding to the back board;

FIG. 4 is an enlarged sectional view showing a main part of the whole configuration of the display device according to the invention;

FIG. 5 is a plan showing the configuration of a spacer shown in FIG. 4;

FIG. 6 is a sectional view viewed along a line I-I shown in FIG. 5;

FIG. 7 is a plan showing the configuration of a spacer for explaining a second embodiment of the display device according to the invention;

FIG. 8 is a sectional view viewed along a line II-II shown in FIG. 7;

FIG. 9 is an enlarged sectional view of a main part showing the structure of a fixing part for fixing a back board and the spacer;

FIG. 10 is an enlarged sectional view showing a main part for explaining another structure of the fixing part for fixing the back board and the spacer;

FIG. 11 is a plan showing the configuration of a spacer for explaining a third embodiment of the display device according to the invention;

FIG. 12 is a plan of a main part showing the configuration of a back board of the display device according to the invention;

FIG. 13 is a plan of a main part showing the configuration of a front board of the display device according to the invention; and

FIG. 14 is an enlarged sectional view of a main part showing the configuration of a fluorescent screen formed on the front board of the display device according to the invention.

### DETAILED DESCRIPTION OF THE PREFERRED EMBODIMENTS

Referring to drawings related to preferred embodiments, the preferred embodiments of the invention will be described in detail below.

### First Embodiment

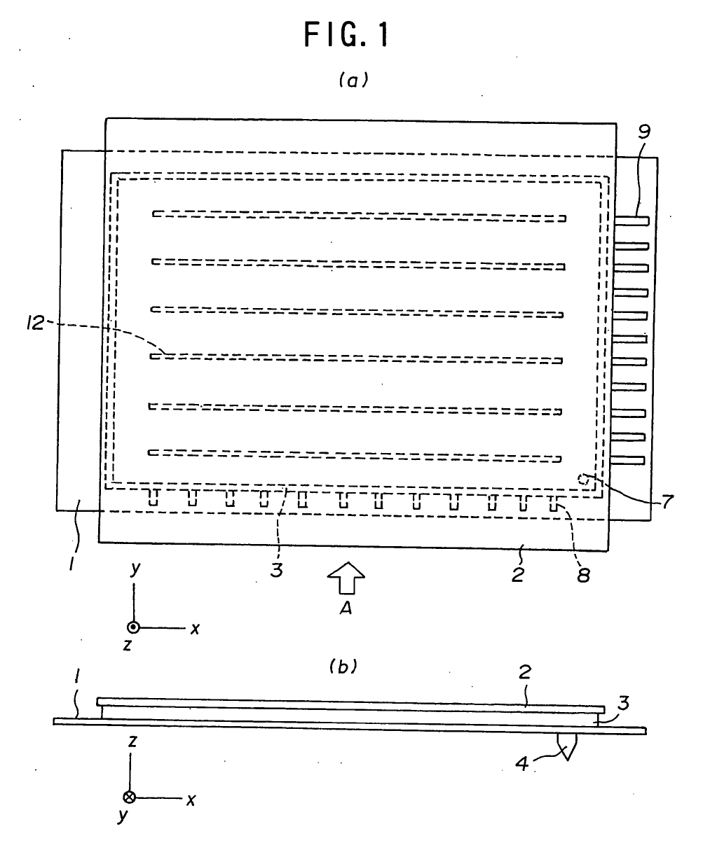

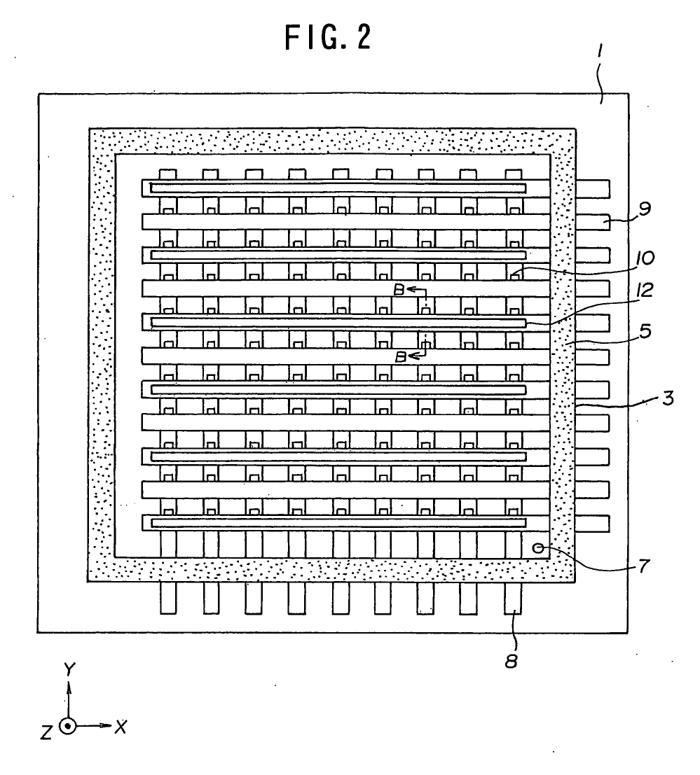

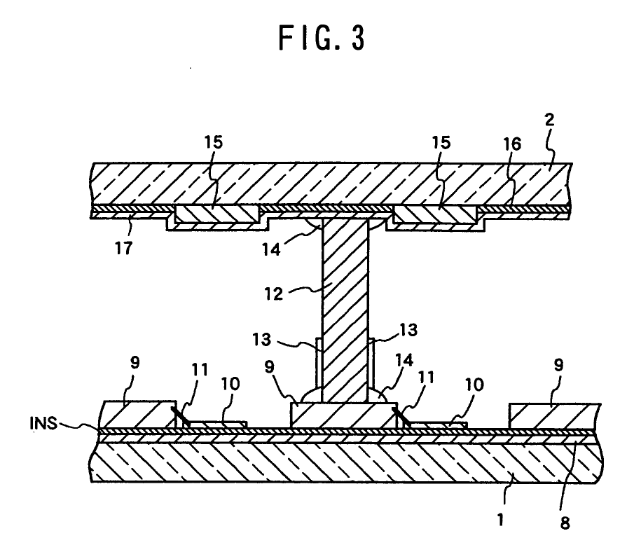

FIGS. 1A, 1B and 2 are explanatory drawings for explaining the configuration in a first embodiment of a display device according to the invention, where FIG. 1A is a plan showing the display device viewed from the side of a front board, FIG. 1B is a side view viewed from a direction shown by an arrow A in FIG. 1A, and FIG. 2 is a schematic plan showing a back board of the display device from which the front board shown in FIGS. 1A and 1B is removed. FIG. 3 is a schematic enlarged sectional view showing the back board viewed along a line B-B shown in FIG. 2 and the front board in a corresponding part to the back board.

As shown in FIGS. 1A to 3, a reference numeral 1 denotes the back board, 2 denotes the front board, and these back board 1 and front board 2 are made of a glass plate a few mm in thickness, for example approximately 3 mm. A reference numeral 3 denotes a frame and the frame 3 is made of a glass plate or a sintered body of fritted glass a few mm in thickness, for example approximately 3 mm. A reference numeral 4 denotes an exhaust pipe and the exhaust pipe 4 is fastened to the back of the back board 1. The frame 3 is arranged between the back board 1 and the front board 2. Besides, the frame 3 is arranged in a circumferential part of an image display area with the frame encircling the image display area. An envelope is formed by sealing the back board 1, the front board 2 and the frame 3 via a sealing member 5 such as fritted glass airtightly.

Air in space encircled by the back board 1, the front board 2, the fame 3 and the sealing member 5 is exhausted through the exhaust pipe 4, and the space is held in a vacuum of approximately 10⁻³ to 10⁻⁵ Pa for example. The exhaust pipe 4 is attached to an outside face of the backboard land communicates with a through hole 7 that pierces the back board 1. The exhaust pipe 4 is chipped off after the exhaust of gas inside the envelope is completed and the envelope is sealed.

A reference numeral 8 denotes picture signal wiring, the picture signal wiring 8 is extended in one direction (in a direction of Y) on the inside of the backboard 1, and is arranged in parallel to the other direction (in a direction of X) with each other. A reference numeral 9 denotes scanning signal wiring, the scanning signal wiring 9 is extended in the other direction (in the direction of X) that crosses the picture signal wiring 8, and is arranged in parallel to one direction (in the direction of Y) with each other. The scanning signal wiring 9 is formed closer to a fluorescent screen than the picture signal wiring 8. A reference numeral 10 denotes an electron emission element, the electron emission element 10 is provided in the vicinity of each crossover of the scanning signal wiring 9 and the picture signal wiring 8, and the scanning signal wiring 9 and the electron emission element 10 are connected via a connecting electrode 11. A layer insulation film INS is arranged between the picture signal wiring 8 and the electron emission element 10 and the scanning signal wiring 9.

For the picture signal wiring 8, a double-layer film formed by an Al film and an Nd film for example is used and for the scanning signal wiring 9, a three-layer film formed by an Ir film, a Pt film and an Au film for example is used.

A reference numeral 12 denotes a spacer for preventing the back board 1 and the front board 2 from being concaved in a direction of the inside of the envelope. The spacer 12 is made of ceramic material (including glass material) for example, and is formed in the shape of a rectangular thin plate. A conductive metallic film 13 described later is formed on a side wall of a base of the spacer. The spacer 12 is normally arranged in a position for every group of plural picture elements in which the operation of a picture element is not hindered. In this embodiment, the spacer 12 is installed upright on the scanning signal wiring 9 every other wiring.

The dimension of the spacer 12 is set depending upon the dimensions of the back board 1 and the front board 2, the height of the frame 3, an interval between the spacers 12, the material of the spacer and others. Generally, for practical values of the spacer, the height is substantially the same as that of the frame 3, the thickness is set to a few tens μm to a few mm or less, and the length is set in a range of 50 to 400 mm, desirably in a range of 80 to 250 mm.

A reference numeral 14 denotes an adhesive member. The adhesive member 14 is made of a conductive adhesive including bonding fritted glass or a vitrifying component and silver for example, and bonds and fixes the spacer 12 to the back board 1 and the front board 2. As for the adhesive member 14, the thickness is set to a few μm or more from a viewpoint of securing adhesion and fixing, desirably to approximately 10 to 40 μm though it may be different depending upon the composition.

In the meantime, on the inside of the front board 2, fluorescent layers 15 for red, green and blue are partitioned by a black matrix (BM) film 16 for shielding light, a metal-backed film (a positive electrode) 17 made of an aluminum deposited film as a reflecting film is formed to cover the layers 15 and the film 16. The fluorescent screen is formed. According to the configuration of the fluorescent screen, an electron emitted from the electron emission element 10 is accelerated and is hit on the fluorescent layers 15 forming the corresponding picture element. Hereby, the fluorescent layers 15 are colored in predetermined color, the predetermined color is mixed with luminescent color by fluorescent material of another picture element, and a predetermined color picture element is formed. The metal-backed film 17 is shown as a surface electrode, however, the metal-backed film also may cross the scanning signal wiring 9 and maybe also a stripe electrode divided every picture element line.

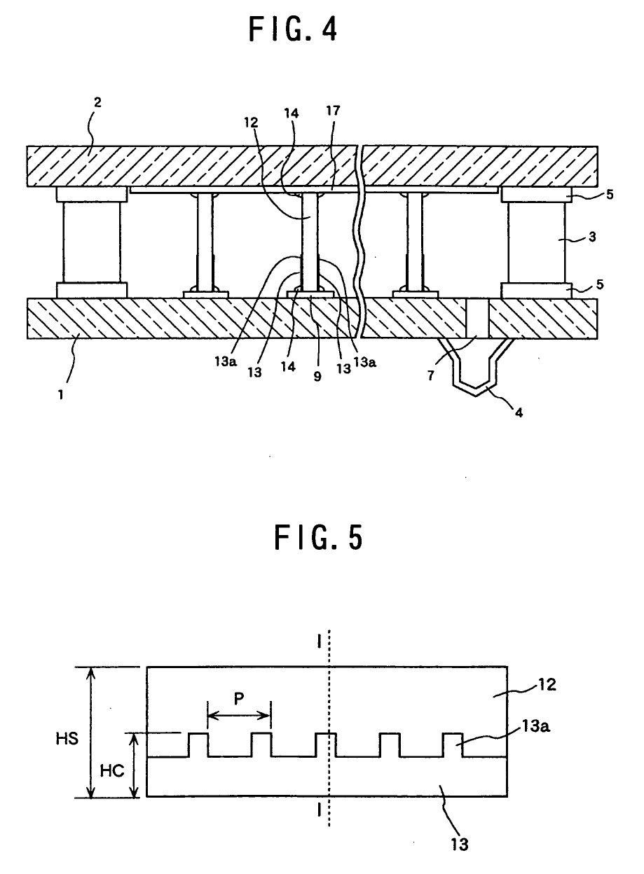

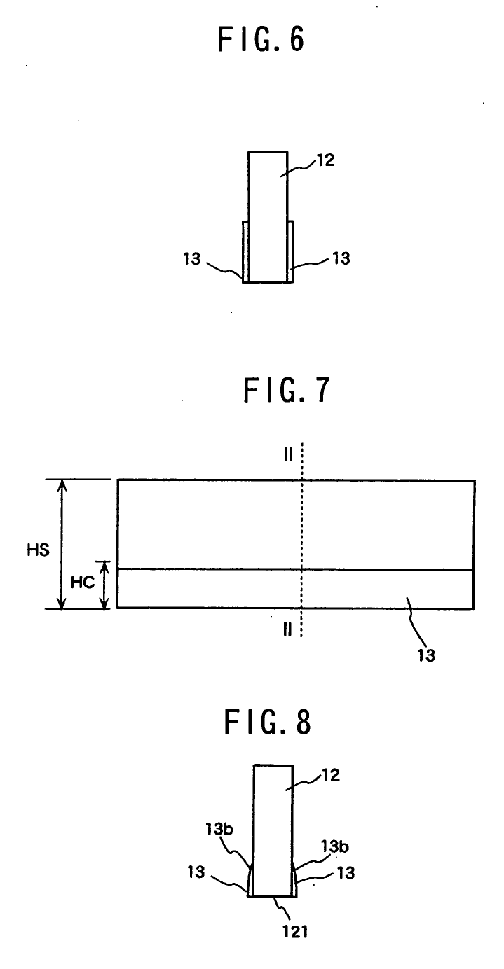

FIGS. 4 to 6 are explanatory drawings for explaining the configuration of the spacer in the first embodiment of the display device according to the invention shown in FIGS. 1A and 1B in detail, FIG. 4 is a schematic sectional view showing a main part viewed in the direction of Y shown in FIGS. 1A and 1B, FIG. 5 is a plan viewed from the side of the spacer, and FIG. 6 is a sectional view viewed along a line I-I shown in FIG. 5. In these drawings, the same reference numeral is allocated to the same part as that in the above-mentioned drawings, and the description is omitted.

The spacer 12 used in the display device is formed in the shape of a thin plate by an insulating material such as ceramic material. The conductive metallic film 13 acquired by sputtering or depositing metallic material such as Al, Cr, Ni, Mo, Ta and Cu, coated on both side walls of the base of the spacer. The conductive metallic film 13 may be also a metallic film with an oxidation inhibiting layer made of any above-mentioned metallic material or may be also a multi-layer film.

The specific resistance of the base of the spacer 12 is approximately 10⁸ to 10⁹ Ω·cm. The conductive metallic film 13 has a height from the side end of the back board 1 toward the side of the front board 2 and has a width along a longitudinal direction of the spacer 12. The surface electrical resistance of the conductive metallic film 13 is 10⁶Ω/□ or less.

The conductive metallic film 13 formed on the side of the back board 1 of the spacer 12 is formed in an overall area in the longitudinal direction of the spacer 12 as shown in FIG. 5 and further, convex portions 13a protruded on the side of the front board 2 are integrated therewith. Pitch P between the convex portions 13a is equal to the height HS of the spacer 12 or in a range of two to ten times. The height HC of the conductive metallic film 13 is in a range of ⅕ to 1/100 of the height HS of the spacer 12, however, it is preferable that the height HC is in a range of 1/10 to 1/50 of the height HS of the spacer 12. It is desirable that difference between the convex portion and a concave portion of the conductive metallic film is 30 μm or more.

As discharge inside a panel is caused between the metal-backed film (the positive electrode) 17 and the convex portions 13a of the conductive metallic film 13 because the conductive metallic film 13 provided with the convex portions 13a is formed on both sides of the base of the spacer 12 in the display device configured as described above, a location in which the discharge is caused can be controlled. Hereby, discharge between the metal-backed film 17 and the electron emission element can be controlled and an insulating layer of the electron emission element or another electrode can be prevented from being broken. Gas can be prevented from being caused in the electron emission element by the breakdown and the luminance of the display device can be prevented from being deteriorated.

### Second Embodiment

FIGS. 7 and 8 are explanatory drawings for explaining the configuration of a spacer in a second embodiment of the display device according to the invention in detail, FIG. 7 is a plan viewed from the side of the spacer, and FIG. 8 is a sectional view viewed along a line II-II shown in FIG. 7. In these drawings, the same reference numeral is allocated to the same part as that in the above-mentioned drawings and the description is omitted.

The spacer 12 used in this display device is formed in a shape of a thin plate by an insulating material such as ceramic material. A conductive metallic film 13 is coated on both side walls of a base of the spacer by sputtering or depositing metallic material such as Al, Cr, Ni, Mo, Ta and Cu for example. The specific resistance of the base of the spacer 12 is approximately 10⁸ to 10⁹ Ω·cm.

The conductive metallic film 13 is formed in an overall area having a fixed height from the side end of a back board toward the side of a front board and a fixed width in a longitudinal direction of the spacer 12. The surface electrical resistance of the conductive metallic film 13 is 10⁶Ω/□ or less on the side of the base of the spacer 12. The height HC of the conductive metallic film 13 is equivalent to ⅕ to 1/100 of the height HS of the spacer 12, however, it is preferable that the height HC is equivalent to 1/10 to 1/50 of the height HS of the spacer 12. Further, the conductive metallic film 13 is formed closer to the side of the back board than the side of the front board.

A thin part 13b in which the conductive metallic film is gradually thinned is integrated with the conductive metallic film 13 on the side of the front board. The thin part 13b is gradually thickened from the side of the side end of the front board of the conductive metallic film 13 toward the side of the back board. In case the thin part 13b is formed in a part of the conductive metallic film 13 on the side of the side end of the front board, a knocking method is used. In a knocking process, the thin part 13b can be formed by instantaneously applying two to three times as much voltage as that in normal operation to a positive electrode and forcedly causing discharge inside a panel.

As in such configuration, the thin part 13b is formed as a part of the conductive metallic film 13, the change of an electric field is slacked in a transition region between the conductive metallic film 13 and the base of the spacer 12, and distortion in the electric field is reduced. Therefore, the orbit of an electron emitted from an electron emission element can be optimized. As the conductive metallic film 13 is gradually thickened from the side of the side end of the front board toward the side of the back board and the thin part 13b is formed, the peeling from the spacer 12 of the conductive metallic film 13 by thermal stress or others can be inhibited.

The thin part 13b of the conductive metallic film 13 may be also formed in an overall area of the end on the side of the front board and may be also formed in a part of the end on the side of the front board.

As the conductive metallic film 13 is formed on both sides of the spacer 12 in the display device configured as described above, discharge is caused between a metal-backed film and the conductive metallic film 13 of the spacer 12. The conductive metallic film 13 in a discharged location has a sectional form that the thin part 13b the end of which is made sharp toward the side of the front board as shown in FIG. 8 is formed. The location in which discharge from the conductive metallic film 13 is often caused can be transformed into a form in which discharge is hardly caused by the knocking process.

Therefore, discharge can be inhibited in normal operation by forming the thin part the end on the side of the front board of which is made sharp as a part of the conductive metallic film 13. As the conductive metallic film 13 is formed on the side of the back board of the spacer 12, even if discharge is caused, discharge is caused between the positive electrode and the conductive metallic film 13 and the electron emission element is not broken. The spacer 12 is installed on wiring and is electrically connected to scanning signal wiring.

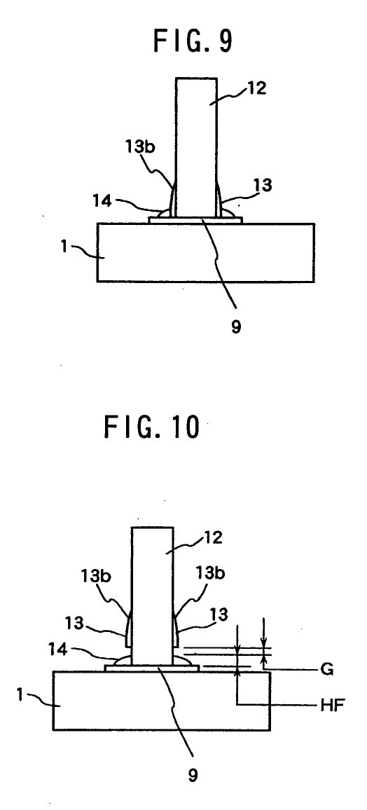

FIG. 9 is an enlarged sectional view showing a main part for explaining the structure of a fixing part for fixing the back board and the spacer, the same reference numeral is allocated to the same part as that in the above-mentioned drawings, and the description is omitted. As shown in FIG. 9, the spacer 12 is fixed to the back board 1 by a conductive adhesive 14. The spacer 12 is arranged on the scanning signal wiring 9. The conductive metallic film 13 is in contact with the conductive adhesive 14.

A base 121 of the spacer 12 is exposed on a face opposite to the back board 1 of the spacer 12. The base on the opposite face of the spacer 12 is fixed to the backboard 1 by the conductive adhesive 14.

That is, no conductive metallic film 13 is formed on the face opposite to the back board 1 of the spacer 12. Therefore, as the conductive adhesive 14 directly contacts the base 121 of the spacer 12 without the conductive metallic film 13, the spacer 12 can be prevented from being removed by the peeling of the conductive metallic film 13. For the conductive adhesive 14, conductive fritted glass including bonding fritted glass or a vitrified component and silver for example is used.

It is desirable that the height of the conductive adhesive 14 is approximately 30 μm. As the conductive adhesive 14 having conductivity has an effect upon the orbit of an electron emitted from the electron emission element, it is desirable that the height is approximately 30 μm or less. As performance for holding the spacer 12 is deteriorated when the height of the conductive adhesive 14 is too low, it is desirable that the height of the conductive adhesive is approximately 20 μm or more.

FIG. 10 is an enlarged sectional view showing a main part for explaining the structure of a part for fixing the back board and the spacer, the same reference numeral is allocated to the same part as that in the above-mentioned drawings, and the description is omitted. As shown in FIG. 10, the spacer 12 is fixed to the back board 1 by a conductive adhesive 14. The spacer 12 is arranged on the scanning signal wiring 9. A gap G of approximately 0.1 mm or less is made between the conductive metallic film 13 and the conductive adhesive 14. As the large frit height HF on which no conductive metallic film 13 exists can be secured between the spacer 12 and the conductive adhesive 14, the spacer 12 can be firmly fixed. In case the gap G is large, conducting means for conducting electricity between the conductive metallic film 13 and the conductive adhesive 14 is required. The conductive metallic film 13 and the conductive adhesive 14 may be also contacted. That is, the spacer 12 can be firmly fixed by the conductive adhesive 14 by forming the conductive metallic film 13 in a position apart from the end of the spacer 12.

### Third Embodiment

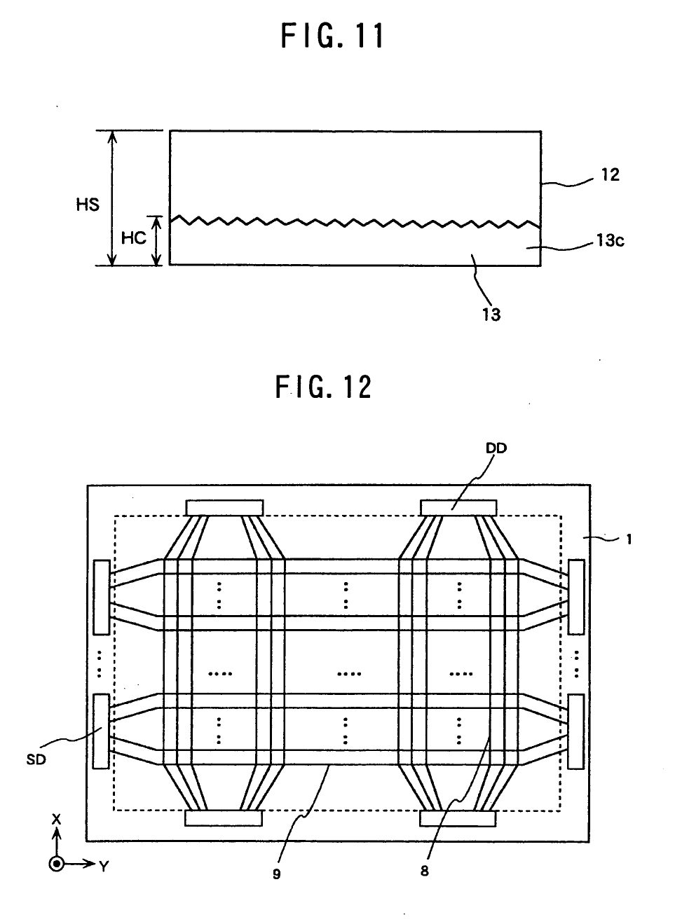

FIG. 11 is a plan viewed from the side of a spacer for explaining the configuration of the spacer in a third embodiment of the display device according to the invention in detail, the same reference numeral is allocated to the same part as that in the above-mentioned drawings, and the description is omitted.

The spacer 12 used in a display device is formed in the shape of a thin plate by an insulating material such as ceramic material. A conductive metallic film 13 is coated on both side walls of a base of the spacer in an overall area in a longitudinal direction by sputtering or depositing metallic material such as Al, Cr, Ni, Ta, Mo and Cu. Further, irregularities 13c are integrated on the side of a front board of the conductive metallic film 13.

The surface electrical resistance of the conductive metallic film 13 is set to 10⁶Ω/□ or less on the side of the base of the spacer 12. The height HC of the conductive metallic film 13 is equivalent to ⅕ to 1/100 of the height HS of the spacer 12, however, it is preferable that the height HC is equivalent to 1/10 to 1/50 of the height HS of the spacer 12. Further, the conductive metallic film 13 is formed in a closer position to the side of a back board than the side of the front board. It is desirable that difference between a convex portion and a concave portion of the conductive metallic film is 30 μm or more.

In such configuration, the conductive metallic film 13 provided with the irregularities 13c on both side walls of the base of the spacer 12 so that discharge is easily caused between the conductive metallic film 13 and a positive electrode. A knocking process is added to a manufacturing process of the display device and discharge is forcedly caused. In the knocking process, discharge is caused between the conductive metallic film 13 and the positive electrode because the conductive metallic film 13 is formed in a shape in which electric fields are easily concentrated and an electron emission element is not broken. Besides, in the knocking process, as two to three times as much voltage as that in normal operation is applied and is discharged, the possibility of discharge in normal operation is reduced.

FIG. 12 is a plan showing a main part viewed from the inside of the back board forming the display device according to the invention. As shown in FIG. 12, on a main surface (a front face) of the back board 1 suitably made of ceramic material (including glass), plural data lines (also called cathode lines) 8 extended in a first direction (in a direction of y) and arranged in parallel with each other in a second direction (in a direction of x) that crosses the first direction, and plural scanning lines 9 extended in the second direction (in the direction of x) and arranged in parallel with each other in the first direction (in the direction of y) that crosses the second direction are provided. The electron emission element formed by a cold cathode is formed in a part in which the data line 8 and the scanning line 9 respectively arranged in a matrix cross or in the vicinity of the part.

One end of the scanning line 9 is connected to a scanning driver SD. In the meantime, one end of the data line 8 is connected to a data driver DD. The front board is arranged opposite along a broken line in the drawing. The front board 2 and the back board 1 are bonded along the peripheries of opposite areas, inside gas is exhausted, and the boards are sealed. The above-mentioned spacer is arranged on the scanning line 9.

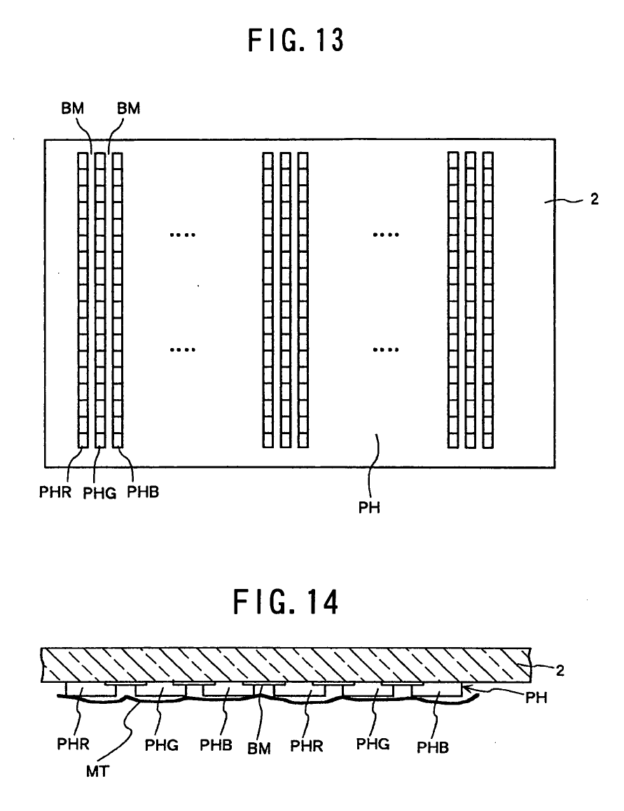

FIG. 13 is a plan showing a main part viewed from the inside of the front board forming the display device according to the invention. As shown in FIG. 13, a fluorescent screen PH provided with a red fluorescent layer PHR, agreen fluorescent layer PHG, and a blue fluorescent layer PHB is formed on the inside of the front board 2 made of transparent glass material in a longitudinal direction of the plurality of data lines 8 shown in FIG. 12 and further, a black matrix film BM for partitioning each of the red fluorescent layer PHR, the green fluorescent layer PHG, and the blue fluorescent layer PHB is formed on the upside of the fluorescent screen PH.

FIG. 14 is an enlarged sectional view showing the fluorescent screen PH formed on the inside of the front board 2. As shown in FIG. 14, the red fluorescent layer PHR, the green fluorescent layer PHG and the blue fluorescent layer PHB respectively forming the fluorescent screen PH cover a part of the black matrix film BM. A metal-backed film MT for efficiently reflecting light emitted from the red fluorescent layer PHR, the green fluorescent layer PHG and the blue fluorescent layer PHB is formed on the fluorescent screen PH. Plate voltage is applied to the metal-backed film MT and the metal-backed film functions as a positive electrode. The above-mentioned spacer is arranged on the black matrix film BM.

As the conductive metallic film is formed on the spacer and discharge is made to be easily caused between the positive electrode and the conductive metallic film in the display device configured as described above, discharge is hardly caused between the electron emission element and the positive electrode. Therefore, the breakdown of the electron emission element can be inhibited. As discharge is forcedly caused between the positive electrode and the conductive metallic film in the knocking process in the manufacturing process of the display device, discharge is hardly caused in normal operation, as discharge in operation can be controlled, the generation of the gas caused by the discharge can be inhibited, and the electron emission element can be operated in a satisfactory condition for a long time.

In the above-mentioned embodiments, the case that the invention is applied to FED has been described using the front board provided with the fluorescent layers and the black matrix films on the inside as the display device and provided with the metal-backed film (the positive electrode) on each back of the fluorescent layers and the black matrix films, however, the invention is not limited to this, and it need scarcely be said that in case the invention is applied to a plasma display panel (PDP) and a panel-type display provided with a metal-insulator electron emission element, the similar effect is also acquired.

What is claimed is:

1. A display device comprising:
an envelope including a front board having a fluorescent layer and a positive electrode;
a back board having an electron emission element and opposite to the front board;
a frame arranged between the front board and the back board; and
a plurality of gap holding members arranged in the envelope,
wherein the gap holding member the surface of which is made of ceramic or glass material comprises a conductive metallic film on side walls of its base, and
wherein the conductive metallic film includes a convex portion protruded on the side of the front board.

2. A display device according to claim 1, wherein:
the gap holding member is made of a ceramic or glass material.

3. A display device according to claim 1, wherein:
the specific resistance of the ceramic or glass material is 10⁸ to 10⁹ Ω·cm.

4. A display device according to claim 1, wherein
the surface electrical resistance of the conductive metallic film is 10⁶Ω/□ or less.

5. A display device comprising:
an envelope including a front board having a fluorescent layer and a positive electrode;
a back board having an electron emission element and is opposite to the front board;
a frame arranged between the front board and the back board; and
a plurality of gap holding members arranged in the envelope,
wherein the gap holding member the surface of which is made of ceramic or glass material is provided with a conductive metallic film on side walls of its base, and
wherein the conductive metallic film includes an area in which the thickness is increased from the side of the front board toward the side of the back board.

6. A display device according to claim 1, wherein:
the height of the conductive metallic film is in a range of ⅕ to 1/100 of the height of the gap holding member.

7. A display device according to claim 1, wherein:
the height of the conductive metallic film is in a range of 1/10 to 1/50 of the height of the gap holding member.

8. A display device according to claim 1, wherein:
the conductive metallic film is formed in a position closer to the back board than the front board.

9. A display device according to claim 1, wherein:
the gap holding member is fixed to the back board by a conductive adhesive member; and
the conductive metallic film is in contact with the conductive adhesive member or is arranged beside the conductive adhesive member via clearance of 0.1 mm or less.

10. A display device according to claim 1, wherein:
an exposed part in which no conductive metallic film is formed is provided at the end of the side wall of a base of the gap holding member; and
the exposed part is fixed to the back board by the conductive adhesive member.

11. A display device according to claim 1, wherein:
a pitch between convex portions of the conductive metallic film is equal to the height of the gap holding member or is equivalent to 2 to 10 times of the height of the gap holding member.

12. A display device comprising:
an envelope including a front board having a fluorescent layer and a positive electrode;
a back board having an electron emission element and is opposite to the front board;
a frame arranged between the front board and the back board; and
a plurality of gap holding members arranged in the envelope,
wherein the gap holding member the surface of which is made of ceramic or glass material is provided with a conductive film on side walls of its base, and
wherein the conductive film is provided with a convex portion protruded on the side of the front board.

13. A display device according to claim 5, wherein:
the height of the conductive metallic film is in a range of ⅕ to 1/100 of the height of the gap holding member.

14. A display device according to claim 5, wherein:
the height of the conductive metallic film is in a range of 1/10 to 1/50 of the height of the gap holding member.

15. A display device according to claim 5, wherein:
the conductive metallic film is formed in a position closer to the back board than the front board.

16. A display device according to claim 5, wherein:
the gap holding member is fixed to the back board by a conductive adhesive member; and
the conductive metallic film is in contact with the conductive adhesive member or is arranged beside the conductive adhesive member via clearance of 0.1 mm or less.

17. A display device according to claim 5, wherein:
an exposed part in which no conductive metallic film is formed is provided at the end of the side wall of a base of the gap holding member; and
the exposed part is fixed to the back board by the conductive adhesive member.

18. A display device according to claim 5, wherein:
a pitch between convex portions of the conductive metallic film is equal to the height of the gap holding member or is equivalent to 2 to 10 times of the height of the gap holding member.
